(19) United States
(12) Patent Application Publication
(10) Pub. No.: US 2026/0214642 A1
(43) Pub. Date: Jul. 23, 2026

(54) SIDELINK RESOURCE ALLOCATION

(71) Applicant: QUALCOMM Incorporated, San Diego, CA (US)

(72) Inventors: Luanxia YANG, Beijing (CN); Jing SUN, San Diego, CA (US); Chih-Hao LIU, San Diego, CA (US); Giovanni CHISCI, San Diego, CA (US); Changlong XU, Beijing (CN); Xiaoxia ZHANG, San Diego, CA (US); Shaozhen GUO, Beijing (CN); Siyi CHEN, Beijing (CN); Hao XU, Beijing (CN)

(21) Appl. No.: 19/138,449

(22) PCT Filed: Feb. 15, 2023
(86) PCT No.: PCT/CN2023/076079

§ 371 Date: Jun. 12, 2025

(51) Int. Cl. H04W 72/02; H04W 72/231; H04W 72/25; H04W 72/541; H04W 74/0816

(52) U.S. Cl. CPC H04W 72/02; H04W 72/231; H04W 72/25; H04W 72/541; H04W 74/0816

(57) ABSTRACT

Various aspects of the present disclosure generally relate to wireless communication. In some aspects, a user equipment (UE) may transmit, to a network node, information associated with resource allocation for a sidelink communication, the information indicating at least one of: a random number associated with a contention window for the sidelink communication, a length of the contention window, an interference measurement associated with a sidelink channel, or a destination identifier for a target of the sidelink communication. The UE may receive, from the network node, an indication of the resource allocation for the sidelink communication. Numerous other aspects are described.

### FIELD OF THE DISCLOSURE

Aspects of the present disclosure generally relate to wireless communication and to techniques and apparatuses for sidelink resource allocation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a UE. The method may include transmitting, to a network node, information associated with resource allocation for a sidelink communication, the information indicating at least one of: a random number associated with a contention window for the sidelink communication, a length of the contention window, an interference measurement associated with a sidelink channel, or a destination identifier for a target of the sidelink communication. The method may include receiving, from the network node, an indication of the resource allocation for the sidelink communication.

Some aspects described herein relate to a method of wireless communication performed by a network node. The method may include receiving information associated with a sidelink communication, the information indicating at least one of: a random number associated with a contention window for the sidelink communication, a length of the contention window, an interference measurement associated with a sidelink channel, or a destination identifier for a target of the sidelink communication. The method may include selecting a resource allocation for the sidelink communication based at least in part on the information. The method may include transmitting an indication of the resource allocation.

Some aspects described herein relate to a UE for wireless communication. The UE may include a memory and one or more processors coupled to the memory. The one or more processors may be configured to transmit, to a network node, information associated with resource allocation for a sidelink communication, the information indicating at least one of: a random number associated with a contention window for the sidelink communication, a length of the contention window, an interference measurement associated with a sidelink channel, or a destination identifier for a target of the sidelink communication. The one or more processors may be configured to receive, from the network node, an indication of the resource allocation for the sidelink communication.

Some aspects described herein relate to a network node for wireless communication. The network node may include a memory and one or more processors coupled to the memory. The one or more processors may be configured to receive information associated with a sidelink communication, the information indicating at least one of” a random number associated with a contention window for the sidelink communication, a length of the contention window, an interference measurement associated with a sidelink channel, or a destination identifier for a target of the sidelink communication. The one or more processors may be configured to select a resource allocation for the sidelink communication based at least in part on the information. The one or more processors may be configured to transmit an indication of the resource allocation.

Some aspects described herein relate to a non-transitory computer-readable medium that stores a set of instructions for wireless communication by a UE. The set of instructions, when executed by one or more processors of the UE, may cause the UE to transmit, to a network node, information associated with resource allocation for a sidelink communication, the information indicating at least one of: a random number associated with a contention window for the sidelink communication, a length of the contention window, an interference measurement associated with a sidelink channel, or a destination identifier for a target of the sidelink communication. The set of instructions, when executed by one or more processors of the UE, may cause the UE to receive, from the network node, an indication of the resource allocation for the sidelink communication.

Some aspects described herein relate to a non-transitory computer-readable medium that stores a set of instructions for wireless communication by a network node. The set of instructions, when executed by one or more processors of the network node, may cause the network node to receive information associated with a sidelink communication, the information indicating at least one of: a random number associated with a contention window for the sidelink communication, a length of the contention window, an interference measurement associated with a sidelink channel, or a destination identifier for a target of the sidelink communication. The set of instructions, when executed by one or more processors of the network node, may cause the network node to select a resource allocation for the sidelink communication based at least in part on the information. The set of instructions, when executed by one or more processors of the network node, may cause the network node to transmit an indication of the resource allocation.

Some aspects described herein relate to an apparatus for wireless communication. The apparatus may include means for transmitting, to a network node, information associated with resource allocation for a sidelink communication, the information indicating at least one of: a random number associated with a contention window for the sidelink communication, a length of the contention window, an interference measurement associated with a sidelink channel, or a destination identifier for a target of the sidelink communication. The apparatus may include means for receiving, from the network node, an indication of the resource allocation for the sidelink communication.

Some aspects described herein relate to an apparatus for wireless communication. The apparatus may include means for receiving information associated with a sidelink communication, the information indicating at least one of: a random number associated with a contention window for the sidelink communication, a length of the contention window, an interference measurement associated with a sidelink channel, or a destination identifier for a target of the sidelink communication. The apparatus may include means for selecting a resource allocation for the sidelink communication based at least in part on the information. The apparatus may include means for transmitting an indication of the resource allocation.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram of an example associated with sidelink resource allocation, in accordance with the present disclosure.

FIG. 6 is a diagram illustrating examples of sidelink resource allocation, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

In some situations, Mode 1 sidelink resource allocation may result in different UEs being allocated with sidelink resources in a manner that can cause interference and communication issues. For example, inter-UE blocking may occur in a situation where resources in consecutive slots are allocated to different UEs. In this situation, a first UE may transmit in a first slot, and a second UE, allocated for a transmission in the next slot, may sense the transmission of the first UE during a listen-before-talk (LBT) procedure, which may cause the second UE to skip the transmission in the next slot due to the LBT failure as a result of detecting the transmission of the first UE. This may result in UEs being unable to transmit on allocated resources, which may lead to delayed transmissions, increased latency, increased network and/or processing overhead for rescheduling, among other issues. This may impact network performance, including increased data usage, increased network traffic and signaling overhead, and/or increased latency, among other examples. In addition, additional processing and/or power resources may be expended to perform additional sensing, transmissions, and/or communications processing, among other examples.

Some techniques and apparatuses described herein enable a UE to provide a network node with information that enables the network node to allocate resources for sidelink communications in a manner designed to avoid inter-UE locking (e.g., to avoid LBT failure due to sidelink transmissions of another UE). For example, a sidelink transmitting UE may provide a network node with information associated with a contention window, sidelink channel interference measurements, and/or a destination identifier for a target of a sidelink communication. The network node may use the information to select a resource allocation for the UE in a manner designed to avoid LBT failure for the UE (and/or for another UE using the sidelink channel). In this way, networking resources may be more efficiently allocated and used in a manner that avoids rescheduling and reduced latency associated with inter-UE blocking. In addition, processing and power resources of network devices and UEs may be conserved by avoiding additional communications and processing operations associated with additional LBT sensing and/or rescheduling, among other examples.

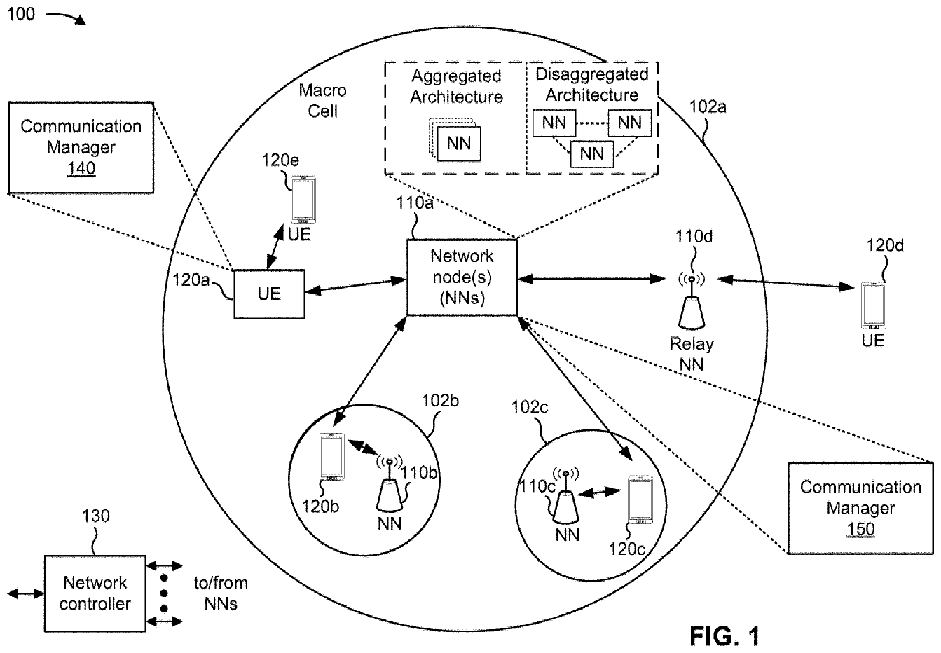

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network node, information associated with resource allocation for a sidelink communication, the information indicating at least one of: a random number associated with a contention window for the sidelink communication, a length of the contention window, an interference measurement associated with a sidelink channel, or a destination identifier for a target of the sidelink communication; and receive, from the network node, an indication of the resource allocation for the sidelink communication. Additionally, or alternatively, the communication manager 140 may perform one or more other operations described herein.

In some aspects, the network node 110 may include a communication manager 150. As described in more detail elsewhere herein, the communication manager 150 may receive information associated with a sidelink communication, the information indicating at least one of: a random number associated with a contention window for the sidelink communication, a length of the contention window, an interference measurement associated with a sidelink channel, or a destination identifier for a target of the sidelink communication; select a resource allocation for the sidelink communication based at least in part on the information; and transmit an indication of the resource allocation. Additionally, or alternatively, the communication manager 150 may perform one or more other operations described herein.

As indicated above, FIG. 1 is provided as an example. Other examples may differ from what is described with regard to FIG. 1.

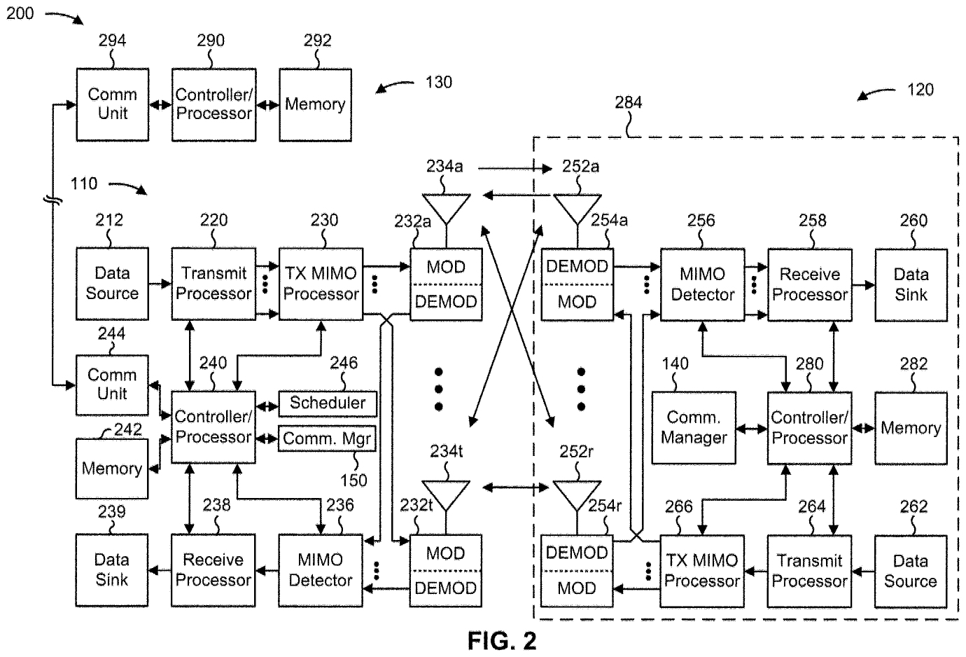

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process sharing indication (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

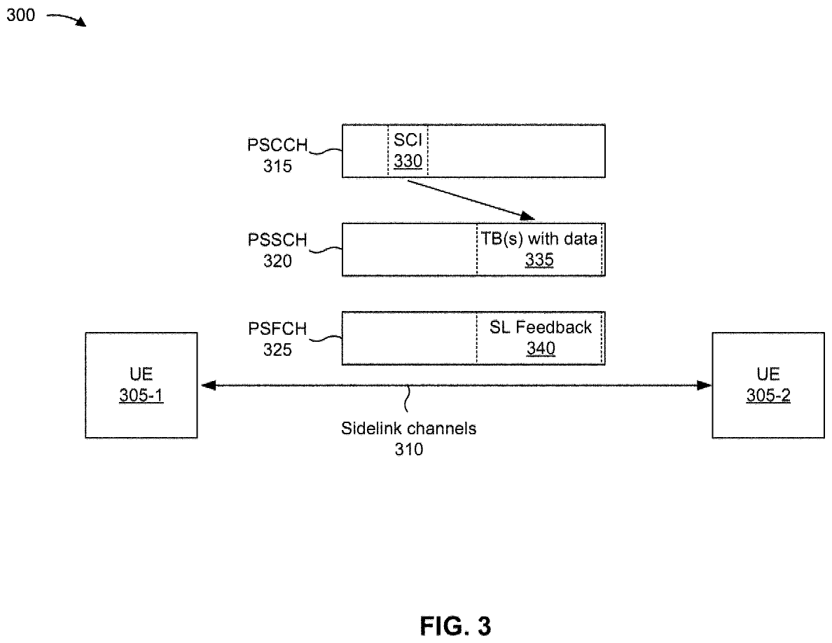

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-10).

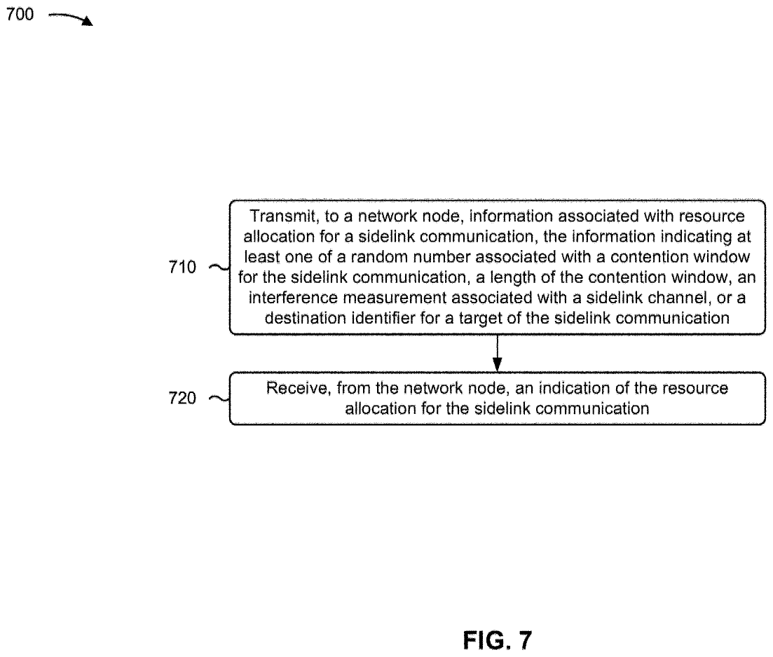

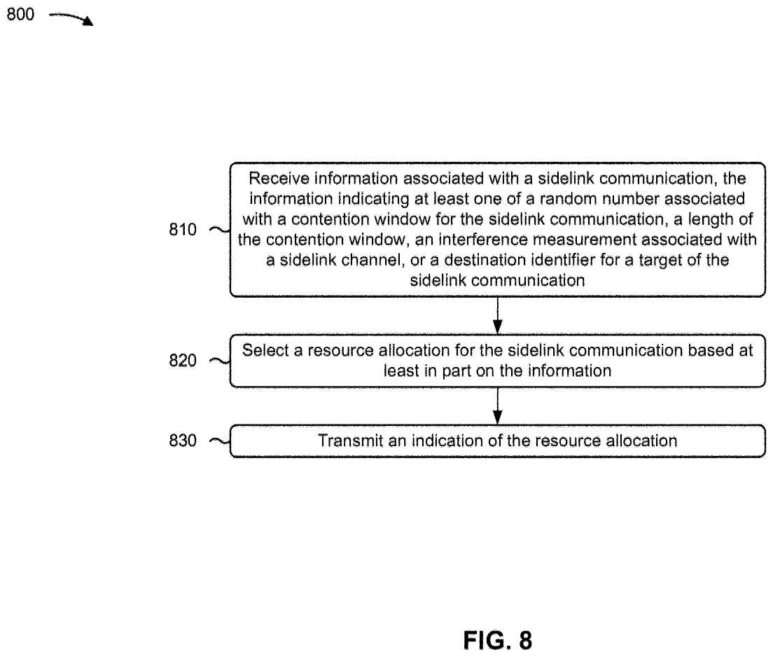

The controller/processor 240 of the network node 110, the controller/processor 280 of the UE 120, and/or any other component(s) of FIG. 2 may perform one or more techniques associated with sidelink resource allocation, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for transmitting, to a network node, information associated with resource allocation for a sidelink communication, the information indicating at least one of: a random number associated with a contention window for the sidelink communication, a length of the contention window, an interference measurement associated with a sidelink channel, or a destination identifier for a target of the sidelink communication; and/or means for receiving, from the network node, an indication of the resource allocation for the sidelink communication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving information associated with a sidelink communication, the information indicating at least one of: a random number associated with a contention window for the sidelink communication, a length of the contention window, an interference measurement associated with a sidelink channel, or a destination identifier for a target of the sidelink communication; means for selecting a resource allocation for the sidelink communication based at least in part on the information; and/or means for transmitting an indication of the resource allocation. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

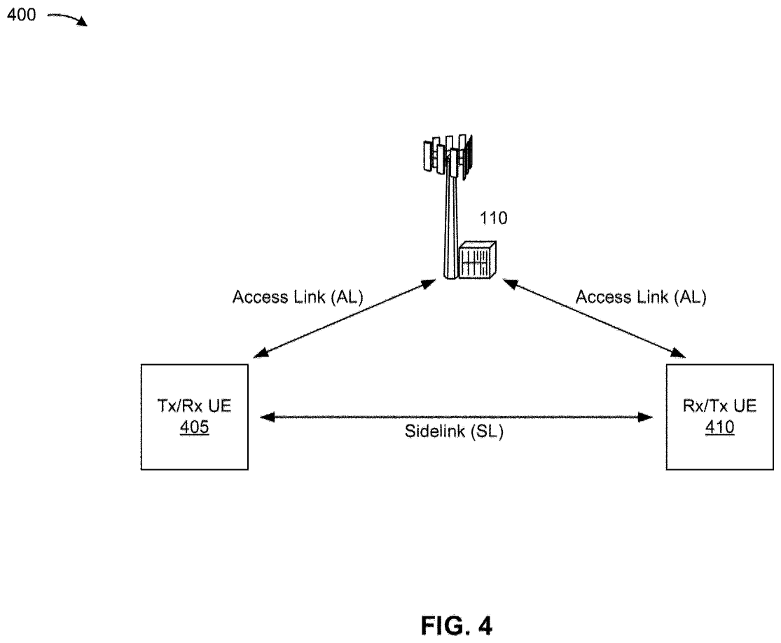

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In both Mode 1 and Mode 2, a Tx UE may use an LBT procedure on at least one sidelink channel. For example, the Tx UE may wait for one or more symbols of a slot (e.g., a portion of a radio frame), and transmit (e.g., to an Rx UE) within that slot only when the Tx UE does not decode a transmission in those one or more symbols. The Tx UE may wait for a preconfigured amount of time or for a dynamic (e.g., randomly or pseudo-randomly determined) amount of time (e.g., determined based on a minimum amount of time, a maximum amount of time, an energy level associated with the transmission, a power class of the Tx UE, an antenna gain associated with the Rx UE, and/or another variable). The amount of time the Tx UE waits may be referred to as a contention window. Accordingly, the LBT procedure may include a carrier sensing multiple access (CSMA) procedure, a clear channel assessment (CCA) procedure, a carrier sensing adaptive transmission (CSAT) procedure, and/or another similar procedure. For example, the Tx UE may use an LBT procedure as set forth in the Institute of Electrical and Electronics Engineers (IEEE) LAN/MAN Standards Committee 802.11 standards, the IEEE Wireless Coexistence Technical Advisory Group (TAG) 802.19 standards, the European Telecommunications Standards Institute (ETSI) Harmonised European Standard (EN) 300 328, and/or another standard. The Tx UE may use the LBT procedure at least in part because the at least one sidelink channel is over an unlicensed band channel. For example, the at least one sidelink channel may use NR unlicensed (NR-U) spectrum.

As indicated above, FIG. 4 is provided as an example. Other examples may differ from what is described with respect to FIG. 4.

In some situations, Mode 1 resource allocation may result in different UEs being allocated with sidelink resources in a manner that causes LBT failure. For example, inter-UE blocking may occur in a situation where resources in consecutive slots are allocated to different UEs. In this situation, a first UE may transmit in a first slot, and a second UE, allocated for a transmission in the next slot, may sense the transmission of the first UE during LBT, which may cause the second UE to skip the transmission in the next slot due to the LBT failure as a result of detecting the transmission of the first UE. This may result in UEs being unable to transmit on allocated resources, which may lead to delayed transmissions, increased latency, increased network and/or processing overhead for rescheduling, among other issues. This may impact network performance, including increased data usage, increased network traffic and signaling overhead, and/or increased latency, among other examples. In addition, additional processing and/or power resources may be expended to perform additional sensing, transmissions, and/or communications processing, among other examples.

Some techniques and apparatuses described herein enable a UE to provide a network node with information that enables the network node to allocate resources for sidelink communications in a manner designed to avoid inter-UE locking (e.g., LBT failure due to sidelink transmissions of another UE). For example, a sidelink transmitting UE may provide a network node with information associated with a contention window, sidelink channel interference measurements, and/or a destination identifier for a target of a sidelink communication. The network node may use the information to select a resource allocation for the UE in a manner designed to avoid LBT failure for the UE (and/or for another UE using the sidelink channel). In this way, networking resources may be more efficiently allocated and used in a manner that avoids rescheduling and reduced latency associated with inter-UE blocking. In addition, processing and power resources of network devices and UEs may be conserved by avoiding additional communications and processing operations associated with additional LBT sensing and/or rescheduling, among other examples.

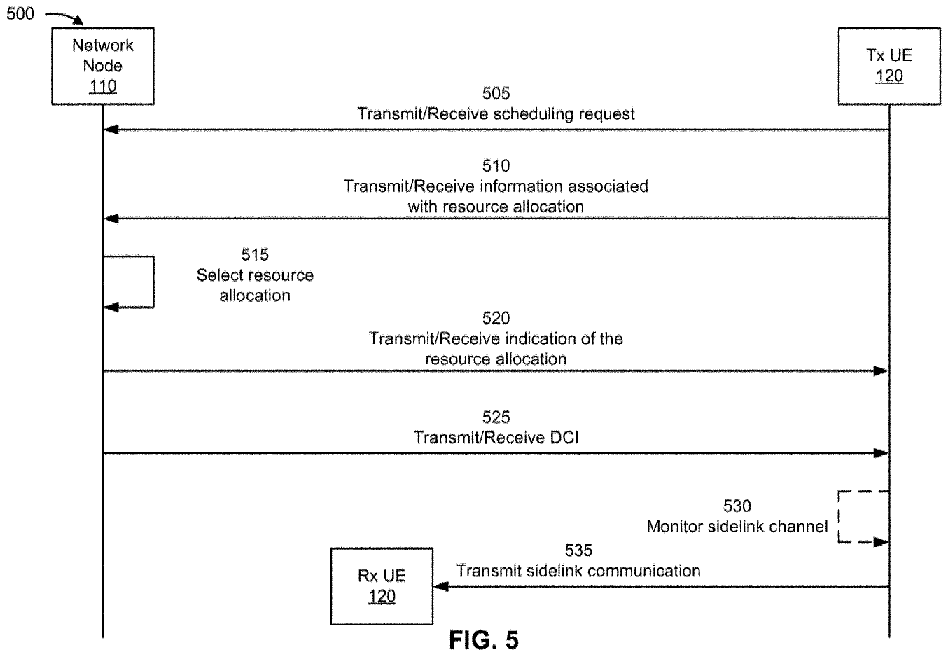

FIG. 5 is a diagram of an example 500 associated with sidelink resource allocation, in accordance with the present disclosure. As shown in FIG. 5, a network node (e.g., network node 110) may communicate with a UE (e.g., Tx UE 120), and the UE may communicate with another UE (e.g., Rx UE 120) via sidelink. In some aspects, the network node and the UEs may be part of a wireless network (e.g., wireless network 100). In some aspects, actions described as being performed by the network node may be performed by multiple different network nodes. For example, configuration actions may be performed by a first network node (e.g., a CU and/or a DU), and radio communication actions may be performed by a second network node (e.g., a DU and/or an RU). The UEs and the network node may have established a wireless connection prior to operations shown in FIG. 5.

As shown by reference number 505, the UE may transmit, and the network node may receive, a scheduling request for a sidelink communication. For example, the UE may be in communication with the network node and operating in Mode 1 for sidelink communications. In this situation, when the UE has data to transmit to another UE via sidelink, the UE may transmit the scheduling request to the network node to receive a resource allocation for the sidelink communication, as described herein.

As shown by reference number 510, the UE may transmit, and the network node may receive, information associated with the sidelink communication. In some aspects, the information may include a random number associated with a contention window for the sidelink communication, a length of the contention window, an interference measurement associated with a sidelink channel, and/or a destination identifier for a target of the sidelink communication.

For example, the random number associated with the contention window may include the random number selected by the UE to indicate the period of time that the UE waits while performing LBT (e.g., the period of time randomly selected between a minimum and maximum amount of time). The length of the contention window may include, for example, the amount of time associated with the contention window (e.g., the minimum and/or maximum amount of time that the UE waits during LBT). The interference measurement may include, for example, an indication of an amount of energy detected in the sidelink channel over a period of time (e.g., measured in dB). The destination identifier for the target of the sidelink communication may include, for example, a layer 1 and/or layer 2 identifier, a radio network temporary identifier (RNTI), an index mapping to a table of UE identifiers, and/or the like. As described herein, the information provided by the UE may enable the network node to select a resource allocation designed to avoid LBT failure and inter-UE locking.

In some aspects, the UE may transmit the information via uplink control information and/or via a medium access control (MAC) control element. In some aspects, the UE may transmit the information via a configured periodic resource or a dedicated uplink resource. For example, the UE may be configured to transmit the information in a next slot after transmission of the scheduling request.

As shown by reference number 515, the network node may select a resource allocation for the sidelink communication. For example, the network node may select a resource allocation based at least in part on the information provided by the UE. In some aspects, the network node may select resources that are not already allocated to other devices, such as other UEs operating in Mode 1 sidelink.

In some aspects, to avoid LBT failure, the network node may select symbols for the resource allocation in a manner that does not conflict with LBT to be performed by the UEs using the sidelink channel. For example, in a situation where the network node allocates a slot to the UE for the sidelink communication, and another UE is scheduled to transmit in the following slot, the network node may identify one or more last symbols of the allocated slot that the UE should not use to ensure that LBT performed by the other UE does not fail.

In some aspects, the network node may indicate whether the UE is to monitor for channel occupancy time (COT) sharing for the resource allocation. A COT may indicate, for example, consecutive resources that are allocated to a particular UE for transmissions by that UE. In a situation where not all resources of the COT are to be used by the UE, the UE may share the COT with one or more other UEs, enabling the other UEs to use the COT. For example, a UE may share the COT allocated for the UE by including a COT indication in a sidelink communication to indicate available resources within the COT. Another UE that receives the COT indication may use a resource included in the COT for a transmission. For example, the recipient of a sidelink transmission may respond to a transmitting UE using the COT of the transmitting UE. This enables UEs to share COTs, which can reduce latency and scheduling overhead. In addition, COT sharing may enable a UE that is using another UE's COT to use a shorter LBT duration for transmissions, as the resources are already allocated to the COT sharing UE and expected to be available.

In some aspects, the network node may indicate a priority associated with the resource allocation. For example, the resource allocation may be associated with a channel access priority class (CAPC) value indicating a priority for the sidelink communication of the UE. In some aspects, the CAPC may be limited by another value, such as the CAPC of another UE's COT. For example, when the network node indicates that the UE may monitor the sidelink channel for COT sharing, the sidelink communication of the UE may have a CAPC limited by the CAPC of the COT that the UE is using.

In some aspects, the network node may select the resource allocation based at least in part on the random number associated with the contention window and/or the length of the contention window. For example, the network node may schedule resources such that they do not interfere with the contention window and/or a random number associated with the contention window for the UE and for other UEs scheduled for transmission in the sidelink channel. In some aspects, the network node may select the resource allocation based at least in part on the interference measurement. For example, the network node may use the interference measurement to predict the contention window. For example, the network node may predict that higher interference may result in a longer contention window, or that lower interference may result in a shorter contention window. The prediction may enable the network node to allocate resources based on the predicted contention window length, as described herein. In some aspects, the network node may select the resource allocation based on the destination identifier for the target of the sidelink communication. For example, in a situation where the target UE of the sidelink communication has a COT allocated, the network node may select resources within the COT of the target UE to enable the UE to use the COT of the target UE. This may enable, for example, a shorter LBT duration for the UE that uses the COT of the target UE.

As shown by reference number 520, the network node may transmit, and the UE may receive, an indication of the resource allocation. For example, the network node may transmit an indication of the resource allocation selected by the network node based at least in part on the information provided by the UE, as described herein.

As shown by reference number 525, the network node may transmit, and the UE may receive, downlink control information (DCI) associated with the resource allocation. In some aspects, the indication of the resource allocation may be included in the DCI. In some aspects, the indication of the resource allocation may be transmitted separately from the DCI. The DCI may indicate various aspects of the resource allocation.

For example, in some aspects, the DCI may include an indication, such as a bit field, to identify an ending symbol for a slot included in the resource allocation. For example, while the UE may be configured (e.g., by radio resource control) to use certain symbols within an allocated slot, when the network node is scheduling a slot to avoid LBT failure for another UE that is allocated a subsequent slot, the network node may shorten the number of symbols that the UE may use for the sidelink communication to avoid LBT failure for the other UE. In some aspects, the DCI may include an indication, such as a bit field, to indicate whether the UE should monitor for COT sharing, as described herein. In some aspects, the DCI may include an indication, such as a bit field, to specify the CAPC value for the resource allocation.

As shown by reference number 530, the UE may monitor the sidelink channel for COT sharing indication. For example, the UE may monitor the sidelink channel for COT sharing indication from another UE based at least in part on the DCI indicating that the resource allocation is eligible for COT sharing. In some aspects, whether the UE monitors for the COT sharing indication may depend on whether the network node has indicated (e.g., via DCI) that the UE should monitor for COT sharing, as described herein. For example, the UE may skip monitoring for COT sharing based at least in part on the DCI indicating that the resource allocation is ineligible for COT sharing. As also described herein, COT sharing may enable the UE to use one or more resources included in the COT of another UE with a shortened LBT duration (e.g., relative to an LBT duration used without COT sharing).

As shown by reference number 535, the UE may transmit the sidelink communication. For example, the UE may transmit the sidelink communication to another UE using the sidelink allocation provided by the network node. In some aspects, the sidelink communication may be transmitted using the COT of another UE, as described herein.

As indicated above, FIG. 5 is provided as an example. Other examples may differ from what is described with respect to FIG. 5.

As described herein, a sidelink transmitting UE may provide a network node with information associated with a sidelink communication. The network node may use the information to select a resource allocation for the UE in a manner designed to avoid LBT failure for the UE (and/or for another UE using the sidelink channel). In this way, networking resources may be more efficiently allocated and used in a manner that avoids rescheduling and reduces latency associated with inter-UE blocking. In addition, processing and power resources of network devices and UEs may be conserved by avoiding additional communications and processing operations associated with additional LBT sensing and/or rescheduling, among other examples.

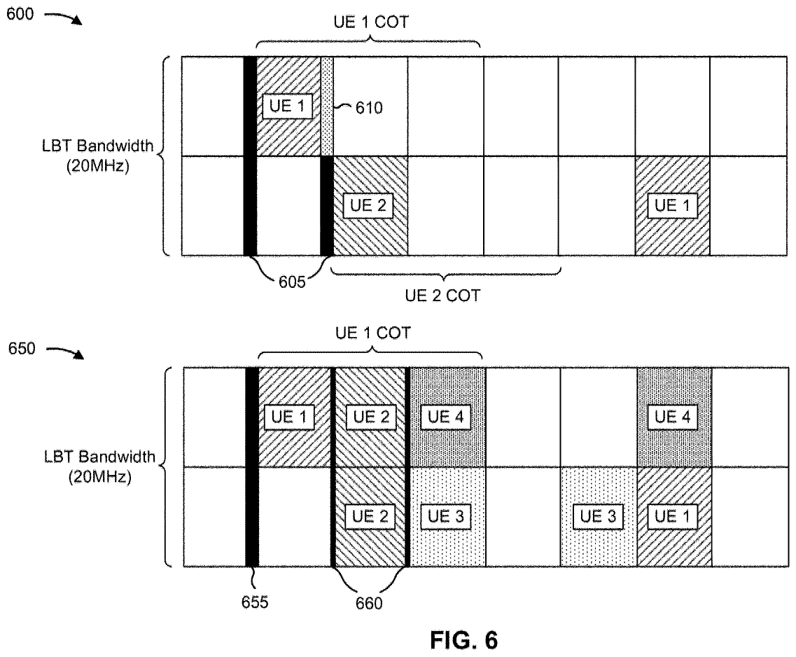

FIG. 6 is a diagram illustrating examples 600 and 650 of sidelink resource allocation, in accordance with the present disclosure. As shown in FIG. 6, an example 20 MHz LBT bandwidth for a sidelink channel is divided into two sub-bands. In a first example 600, UE 2 (e.g., a UE 120) has been allocated a COT spanning three slots in a bottom sub-band and is transmitting in the first slot of the COT (e.g., the third slot shown). UE 1 (e.g., another UE 120) has been allocated a COT spanning three slots in a top sub-band and is also transmitting in the first slot of the COT (e.g., the second slot shown). LBT windows 605 are shown for both UE 1 and UE 2. Because the LBT window for UE 2 is in the slot prior to the COT for UE 2, if UE 1 were to use the full duration of the second slot, UE 2 may detect the transmission during LBT and LBT for UE 2 may fail. To avoid the LBT failure, in this example, UE 1 was provided with a gap 610 during which UE 1 will not transmit. For example, the network node allocating the sidelink resources for UE 1 may have identified the potential overlap in the transmission of UE 1 and the LBT of UE 2 and identified an ending symbol within the first slot of UE 1's COT. The ending symbol, in this example, corresponds to the beginning of LBT for UE 2. This enables UE 1 to transmit in a slot prior to UE 2 without interfering with LBT of UE 2, avoiding inter-UE blocking.

In a second example 650, COT sharing is being used to share the COT of UE 1 with UE 2, UE 3, and UE 4. For example, the network node may indicate, to UE 2, UE 3, and UE 4 that they should monitor for COT sharing, and UE 1 may transmit COT sharing indication that enables the other UEs to use the allocated resources with the COT of UE 1. In this example situation, the LBT window 655 is shown as being longer (e.g., a CAT 4 LBT window) than the LBT windows 660 for UE 2 and UE 3 (e.g., CAT 1 and/or CAT 2 LBT windows). In this way, a network node may allocate resources for sidelink communications to share COTs and avoid LBT failures, which may result in a more efficient use of network resources, processing resources, and power resources of the UEs and other network devices, as described herein.

As indicated above, FIG. 6 is provided as an example. Other examples may differ from what is described with respect to FIG. 6. For example, LBT bandwidths other than 20 MHz may be used, no sub-bands may be used, or more than two sub-bands may be used for sidelink resource allocation.

FIG. 7 is a diagram illustrating an example process 700 performed, for example, by a UE, in accordance with the present disclosure. Example process 700 is an example where the UE (e.g., UE 120) performs operations associated with sidelink resource allocation.

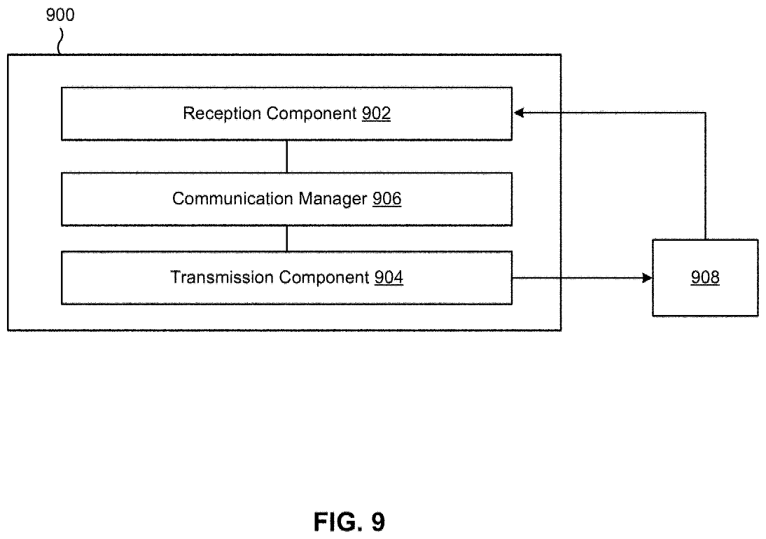

As shown in FIG. 7, in some aspects, process 700 may include transmitting, to a network node, information associated with resource allocation for a sidelink communication, the information indicating at least one of: a random number associated with a contention window for the sidelink communication, a length of the contention window, an interference measurement associated with a sidelink channel, or a destination identifier for a target of the sidelink communication (block 710). For example, the UE (e.g., using transmission component 904 and/or communication manager 906, depicted in FIG. 9) may transmit, to a network node, information associated with resource allocation for a sidelink communication, the information indicating at least one of: a random number associated with a contention window for the sidelink communication, a length of the contention window, an interference measurement associated with a sidelink channel, or a destination identifier for a target of the sidelink communication, as described above.

As further shown in FIG. 7, in some aspects, process 700 may include receiving, from the network node, an indication of the resource allocation for the sidelink communication (block 720). For example, the UE (e.g., using reception component 902 and/or communication manager 906, depicted in FIG. 9) may receive, from the network node, an indication of the resource allocation for the sidelink communication, as described above.

Process 700 may include additional aspects, such as any single aspect or any combination of aspects described below and/or in connection with one or more other processes described elsewhere herein.

In a first aspect, transmitting the information comprises transmitting the information via at least one of uplink control information, or a MAC control element.

In a second aspect, alone or in combination with the first aspect, transmitting the information comprises transmitting the information via a configured periodic resource.

In a third aspect, alone or in combination with one or more of the first and second aspects, transmitting the information comprises transmitting the information via a dedicated uplink resource.

In a fourth aspect, alone or in combination with one or more of the first through third aspects, process 700 includes receiving, from the network node, DCI indicating an ending symbol for a last slot of the resource allocation.

In a fifth aspect, alone or in combination with one or more of the first through fourth aspects, the ending symbol is prior to a preconfigured ending symbol associated with the resource allocation.

In a sixth aspect, alone or in combination with one or more of the first through fifth aspects, process 700 includes receiving, from the network node, DCI indicating a channel occupancy priority class associated with the resource allocation.

In a seventh aspect, alone or in combination with one or more of the first through sixth aspects, process 700 includes receiving, from the network node, DCI indicating whether the resource allocation is eligible for COT sharing.

In an eighth aspect, alone or in combination with one or more of the first through seventh aspects, process 700 includes monitoring the sidelink channel for COT sharing indication based at least in part on the DCI indicating that the resource allocation is eligible for COT sharing.

In a ninth aspect, alone or in combination with one or more of the first through eighth aspects, process 700 includes skipping monitoring the sidelink channel for COT sharing indication based at least in part on the DCI indicating that the resource allocation is ineligible for COT sharing.

In a tenth aspect, alone or in combination with one or more of the first through ninth aspects, process 700 includes transmitting a scheduling request for the sidelink communication, and transmitting the information comprises transmitting the information in a first available uplink resource after transmitting the scheduling request.

In an eleventh aspect, alone or in combination with one or more of the first through tenth aspects, process 700 includes transmitting the sidelink communication using the resource allocation.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with sidelink resource allocation.

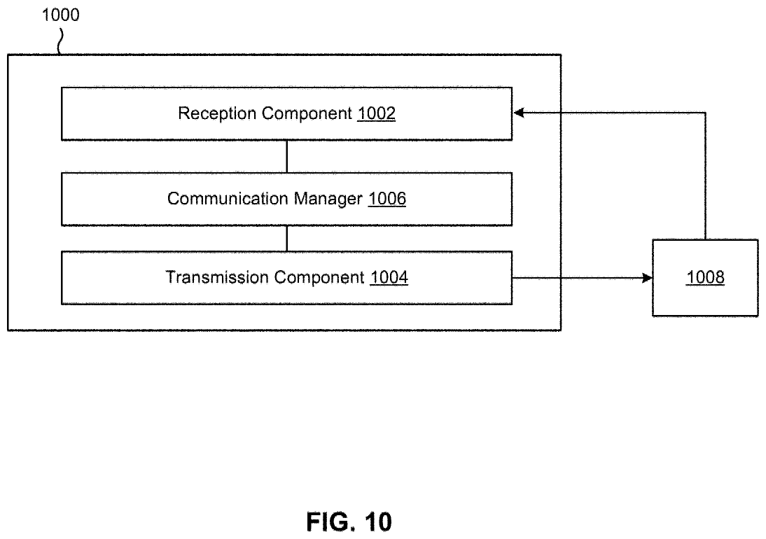

As shown in FIG. 8, in some aspects, process 800 may include receiving information associated with a sidelink communication, the information indicating at least one of: a random number associated with a contention window for the sidelink communication, a length of the contention window, an interference measurement associated with a sidelink channel, or a destination identifier for a target of the sidelink communication (block 810). For example, the network node (e.g., using reception component 1002 and/or communication manager 1006, depicted in FIG. 10) may receive information associated with a sidelink communication, the information indicating at least one of: a random number associated with a contention window for the sidelink communication, a length of the contention window, an interference measurement associated with a sidelink channel, or a destination identifier for a target of the sidelink communication, as described above.

As further shown in FIG. 8, in some aspects, process 800 may include selecting a resource allocation for the sidelink communication based at least in part on the information (block 820). For example, the network node (e.g., using communication manager 1006, depicted in FIG. 10) may select a resource allocation for the sidelink communication based at least in part on the information, as described above.

As further shown in FIG. 8, in some aspects, process 800 may include transmitting an indication of the resource allocation (block 830). For example, the network node (e.g., using transmission component 1004 and/or communication manager 1006, depicted in FIG. 10) may transmit an indication of the resource allocation, as described above.

Process 800 may include additional aspects, such as any single aspect or any combination of aspects described below and/or in connection with one or more other processes described elsewhere herein.

In a first aspect, receiving the information comprises receiving the information via at least one of uplink control information, or a MAC control element.

In a second aspect, alone or in combination with the first aspect, receiving the information comprises receiving the information via a configured periodic resource.

In a third aspect, alone or in combination with one or more of the first and second aspects, receiving the information comprises receiving the information via a dedicated uplink resource.

In a fourth aspect, alone or in combination with one or more of the first through third aspects, process 800 includes transmitting DCI indicating an ending symbol for a last slot of the resource allocation.

In a fifth aspect, alone or in combination with one or more of the first through fourth aspects, the ending symbol is prior to a preconfigured ending symbol associated with the resource allocation.

In a sixth aspect, alone or in combination with one or more of the first through fifth aspects, process 800 includes transmitting DCI indicating a channel occupancy priority class associated with the resource allocation.

In a seventh aspect, alone or in combination with one or more of the first through sixth aspects, process 800 includes transmitting DCI indicating whether the resource allocation is eligible for COT sharing.

In an eighth aspect, alone or in combination with one or more of the first through seventh aspects, transmitting the indication of the resource allocation comprises transmitting the indication of the resource allocation to a first UE, and process 800 includes transmitting another indication of another resource allocation to a second UE based at least in part on the resource allocation being eligible for COT sharing.

In a ninth aspect, alone or in combination with one or more of the first through eighth aspects, process 800 includes receiving a scheduling request for the sidelink communication, and receiving the information comprises receiving the information in a first available uplink resource after receiving the scheduling request.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, to a network node, information associated with resource allocation for a sidelink communication, the information indicating at least one of a random number associated with a contention window for the sidelink communication, a length of the contention window, an interference measurement associated with a sidelink channel, or a destination identifier for a target of the sidelink communication. The reception component 902 may receive, from the network node, an indication of the resource allocation for the sidelink communication.

The reception component 902 may receive, from the network node, DCI indicating an ending symbol for a last slot of the resource allocation.

The reception component 902 may receive, from the network node, DCI indicating a channel occupancy priority class associated with the resource allocation.

The reception component 902 may receive, from the network node, DCI indicating whether the resource allocation is eligible for COT sharing.

The communication manager 906 may monitor the sidelink channel for COT sharing indication based at least in part on the DCI indicating that the resource allocation is eligible for COT sharing.

The communication manager 906 may skip monitoring the sidelink channel for COT sharing indication based at least in part on the DCI indicating that the resource allocation is ineligible for COT sharing.

The transmission component 904 may transmit a scheduling request for the sidelink communication.

The transmission component 904 may transmit the sidelink communication using the resource allocation.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 3-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive information associated with a sidelink communication, the information indicating at least one of a random number associated with a contention window for the sidelink communication, a length of the contention window, an interference measurement associated with a sidelink channel, or a destination identifier for a target of the sidelink communication. The communication manager 1006 may select a resource allocation for the sidelink communication based at least in part on the information. The transmission component 1004 may transmit an indication of the resource allocation.

The transmission component 1004 may transmit DCI indicating an ending symbol for a last slot of the resource allocation.

The transmission component 1004 may transmit DCI indicating a channel occupancy priority class associated with the resource allocation.

The transmission component 1004 may transmit DCI indicating whether the resource allocation is eligible for COT sharing.

The reception component 1002 may receive a scheduling request for the sidelink communication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: transmitting, to a network node, information associated with resource allocation for a sidelink communication, the information indicating at least one of: a random number associated with a contention window for the sidelink communication, a length of the contention window, an interference measurement associated with a sidelink channel, or a destination identifier for a target of the sidelink communication; and receiving, from the network node, an indication of the resource allocation for the sidelink communication.

Aspect 2: The method of Aspect 1, wherein transmitting the information comprises: transmitting the information via at least one of: uplink control information, or a MAC control element.

Aspect 3: The method of any of Aspects 1-2, wherein transmitting the information comprises: transmitting the information via a configured periodic resource.

Aspect 4: The method of any of Aspects 1-3, wherein transmitting the information comprises: transmitting the information via a dedicated uplink resource.

Aspect 5: The method of any of Aspects 1-4, further comprising: receiving, from the network node, DCI indicating an ending symbol for a last slot of the resource allocation.

Aspect 6: The method of Aspect 5, wherein the ending symbol is prior to a preconfigured ending symbol associated with the resource allocation.

Aspect 7: The method of any of Aspects 1-6, further comprising: receiving, from the network node, DCI indicating a channel occupancy priority class associated with the resource allocation.

Aspect 8: The method of any of Aspects 1-7, further comprising: receiving, from the network node, DCI indicating whether the resource allocation is eligible for COT sharing.

Aspect 9: The method of Aspect 8, further comprising: monitoring the sidelink channel for COT sharing indication based at least in part on the DCI indicating that the resource allocation is eligible for COT sharing.

Aspect 10: The method of Aspect 8, further comprising: skipping monitoring the sidelink channel for COT sharing indication based at least in part on the DCI indicating that the resource allocation is ineligible for COT sharing.

Aspect 11: The method of any of Aspects 1-10, further comprising: transmitting a scheduling request for the sidelink communication; and wherein transmitting the information comprises: transmitting the information in a first available uplink resource after transmitting the scheduling request. wherein transmitting the information comprises: transmitting the information in a first available uplink resource after transmitting the scheduling request.

Aspect 12: The method of any of Aspects 1-11, further comprising: transmitting the sidelink communication using the resource allocation.

Aspect 13: A method of wireless communication performed by a network node, comprising: receiving information associated with a sidelink communication, the information indicating at least one of: a random number associated with a contention window for the sidelink communication, a length of the contention window, an interference measurement associated with a sidelink channel, or a destination identifier for a target of the sidelink communication; selecting a resource allocation for the sidelink communication based at least in part on the information; and transmitting an indication of the resource allocation.

Aspect 14: The method of Aspect 13, wherein receiving the information comprises: receiving the information via at least one of: uplink control information, or a MAC control element.

Aspect 15: The method of any of Aspects 13-14, wherein receiving the information comprises: receiving the information via a configured periodic resource.

Aspect 16: The method of any of Aspects 13-15, wherein receiving the information comprises: receiving the information via a dedicated uplink resource.

Aspect 17: The method of any of Aspects 13-16, further comprising: transmitting DCI indicating an ending symbol for a last slot of the resource allocation.

Aspect 18: The method of Aspect 17, wherein the ending symbol is prior to a preconfigured ending symbol associated with the resource allocation.

Aspect 19: The method of any of Aspects 13-18, further comprising: transmitting DCI indicating a channel occupancy priority class associated with the resource allocation.

Aspect 20: The method of any of Aspects 13-19, further comprising: transmitting DCI indicating whether the resource allocation is eligible for COT sharing.

Aspect 21: The method of Aspect 20, wherein transmitting the indication of the resource allocation comprises: transmitting the indication of the resource allocation to a first UE; and wherein the method further comprises: transmitting another indication of another resource allocation to a second UE based at least in part on the resource allocation being eligible for COT sharing.

Aspect 22: The method of any of Aspects 13-21, further comprising: receiving a scheduling request for the sidelink communication; and wherein receiving the information comprises: receiving the information in a first available uplink resource after receiving the scheduling request. wherein receiving the information comprises: receiving the information in a first available uplink resource after receiving the scheduling request.

Aspect 23: An apparatus for wireless communication at a device, comprising a processor; memory coupled with the processor; and instructions stored in the memory and executable by the processor to cause the apparatus to perform the method of one or more of Aspects 1-12.

Aspect 24: An apparatus for wireless communication at a device, comprising a processor; memory coupled with the processor; and instructions stored in the memory and executable by the processor to cause the apparatus to perform the method of one or more of Aspects 13-22.

Aspect 25: A device for wireless communication, comprising a memory and one or more processors coupled to the memory, the one or more processors configured to perform the method of one or more of Aspects 1-12.

Aspect 26: A device for wireless communication, comprising a memory and one or more processors coupled to the memory, the one or more processors configured to perform the method of one or more of Aspects 13-22.

Aspect 27: An apparatus for wireless communication, comprising at least one means for performing the method of one or more of Aspects 1-12.

Aspect 28: An apparatus for wireless communication, comprising at least one means for performing the method of one or more of Aspects 13-22.

Aspect 29: A non-transitory computer-readable medium storing code for wireless communication, the code comprising instructions executable by a processor to perform the method of one or more of Aspects 1-12.

Aspect 30: A non-transitory computer-readable medium storing code for wireless communication, the code comprising instructions executable by a processor to perform the method of one or more of Aspects 13-22.

Aspect 31: A non-transitory computer-readable medium storing a set of instructions for wireless communication, the set of instructions comprising one or more instructions that, when executed by one or more processors of a device, cause the device to perform the method of one or more of Aspects 1-12.

Aspect 32: A non-transitory computer-readable medium storing a set of instructions for wireless communication, the set of instructions comprising one or more instructions that, when executed by one or more processors of a device, cause the device to perform the method of one or more of Aspects 13-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
transmit, to a network node, information associated with resource allocation for a sidelink communication, the information indicating at least one of:
a random number associated with a contention window for the sidelink communication,
a length of the contention window,
an interference measurement associated with a sidelink channel, or
a destination identifier for a target of the sidelink communication; and
receive, from the network node, an indication of the resource allocation for the sidelink communication.

2. The UE of claim 1, wherein the one or more processors, to transmit the information, are configured to:
transmit the information via at least one of:
uplink control information, or
a medium access control (MAC) control element.

3. The UE of claim 1, wherein the one or more processors, to transmit the information, are configured to:
transmit the information via a configured periodic resource.

4. The UE of claim 1, wherein the one or more processors, to transmit the information, are configured to:
transmit the information via a dedicated uplink resource.

5. The UE of claim 1, wherein the one or more processors are further configured to:
receive, from the network node, downlink control information (DCI) indicating an ending symbol for a last slot of the resource allocation.

6. The UE of claim 5, wherein the ending symbol is prior to a preconfigured ending symbol associated with the resource allocation.

7. The UE of claim 1, wherein the one or more processors are further configured to:
receive, from the network node, downlink control information (DCI) indicating a channel occupancy priority class associated with the resource allocation.

8. The UE of claim 1, wherein the one or more processors are further configured to:
receive, from the network node, downlink control information (DCI) indicating whether the resource allocation is eligible for channel occupancy time (COT) sharing.

9. The UE of claim 8, wherein the one or more processors are further configured to:
monitor the sidelink channel for COT sharing indication based at least in part on the DCI indicating that the resource allocation is eligible for COT sharing.

10. The UE of claim 8, wherein the one or more processors are further configured to:
skip monitoring the sidelink channel for COT sharing indication based at least in part on the DCI indicating that the resource allocation is ineligible for COT sharing.

11. The UE of claim 1, wherein the one or more processors are further configured to:
transmit a scheduling request for the sidelink communication; and
wherein the one or more processors, to transmit the information, are configured to:
transmit the information in a first available uplink resource after transmitting the scheduling request.

12. The UE of claim 1, wherein the one or more processors are further configured to:
transmit the sidelink communication using the resource allocation.

13. A network node for wireless communication, comprising:
a memory; and
one or more processors, coupled to the memory, configured to:
receive information associated with a sidelink communication, the information indicating at least one of:
a random number associated with a contention window for the sidelink communication,
a length of the contention window,
an interference measurement associated with a sidelink channel, or
a destination identifier for a target of the sidelink communication;
select a resource allocation for the sidelink communication based at least in part on the information; and
transmit an indication of the resource allocation.

14. The network node of claim 13, wherein the one or more processors, to receive the information, are configured to:
receive the information via at least one of:
uplink control information, or
a medium access control (MAC) control element.

15. The network node of claim 13, wherein the one or more processors, to receive the information, are configured to:
receive the information via a configured periodic resource.

16. The network node of claim 13, wherein the one or more processors, to receive the information, are configured to:
receive the information via a dedicated uplink resource.

17. The network node of claim 13, wherein the one or more processors are further configured to:
transmit downlink control information (DCI) indicating an ending symbol for a last slot of the resource allocation.

18. The network node of claim 17, wherein the ending symbol is prior to a preconfigured ending symbol associated with the resource allocation.

19. The network node of claim 13, wherein the one or more processors are further configured to:
transmit downlink control information (DCI) indicating a channel occupancy priority class associated with the resource allocation.

20. The network node of claim 13, wherein the one or more processors are further configured to:
transmit downlink control information (DCI) indicating whether the resource allocation is eligible for channel occupancy time (COT) sharing.

21.-30. (canceled)
